(19) United States
(12) Patent Application Publication
(10) Pub. No.: US 2024/0169210 A1
(43) Pub. Date: May 23, 2024

(54) METHODS FOR 3D TENSOR BUILDER FOR INPUT TO MACHINE LEARNING

(71) Applicant: Tektronix, Inc., Beaverton, OR (US)

(72) Inventors: Kan Tan, Portland, OR (US); John J. Pickerd, Hillsboro, OR (US)

(73) Assignee: Tektronix, Inc., Beaverton, OR (US)

(21) Appl. No.: 18/510,234

(22) Filed: Nov. 15, 2023

Related U.S. Application Data
(60) Provisional application No. 63/426,708, filed on Nov. 18, 2022.

(51) Int. Cl. G06N 3/09

(52) U.S. Cl. CPC G06N 3/09

(57) ABSTRACT

A test and measurement instrument includes a port to connect to a device under test (DUT) to receive waveform data, a connection to a machine learning network, and one or more processors configured to: receive one or more inputs about a three-dimensional (3D) tensor image; scale the waveform data to fit within the 3D tensor image; build the 3D tensor image; send the 3D tensor image to the machine learning network; and receive a predictive result from the machine learning network. A method includes receiving waveform data from one or more device under test (DUT), receiving one or more inputs about a three-dimensional (3D) tensor image, scaling the waveform data to fit within the 3D tensor image, building the 3D tensor image, sending the 3D tensor image to a pre-trained machine learning network, and receiving a predictive result from the machine learning network.

### CROSS-REFERENCE TO RELATED APPLICATIONS

This disclosure claims benefit of U.S. Provisional Application No. 63/426,708, titled “METHODS FOR 3D TENSOR BUILDER FOR INPUT TO MACHINE LEARNING, filed on Nov. 18, 2022, the disclosure of which is incorporated herein by reference in its entirety.

### TECHNICAL FIELD

This disclosure relates to test and measurement systems and methods, and more particularly to test and measurement systems that employ machine learning.

### DESCRIPTION

U.S. patent application Ser. No. 17/747,954, filed May 18, 2022, titled “SHORT PATTERN WAVEFORM DATABASE BASED MACHINE LEARNING FOR MEASUREMENT,” hereinafter “the '954 application,” describes the use of a tensor image, constructed from a database of short pattern waveforms, as input to a machine learning system. The contents of the '954 application are hereby incorporated by reference into this disclosure.

U.S. patent application Ser. No. 18/199,846, filed May 19, 2023, titled “AUTOMATED CAVITY FILTER TUNING USING MACHINE LEARNING,” hereinafter “the '846 application,” the contents of which are hereby incorporated by reference, describes the use of a tensor image, constructed from plots of measured S-parameters of a device under test, as input to a machine learning system.

U.S. patent application Ser. No. 17/877,829, filed Jul. 29, 2022, titled “COMBINED TDECQ MEASUREMENT AND TRANSMITTER TUNING USING MACHINE LEARNING,” hereinafter “the '829 application,” the contents of which are hereby incorporated by reference into this disclosure in their entirety, describes a test system that employs a machine learning component, which can be used for predicting optimal tuning parameters for a device under test (DUT), such as an optical transceiver or transmitter, for example. The test system described in the '829 application may also employ a machine learning component for predicting a performance measurement or attribute of the DUT, such as a TDECQ measurement, for example. Both sets of predictions are assisted with trained deep learning neural networks. The test system described in the '829 application may include a tensor image builder to construct a tensor image, such as the tensor image described in the '954 application as input to the deep learning networks. The deep learning networks may be a component of a software application, which may be referred to in this disclosure interchangeably as the OptaML™ application, the OptaML™ Pro application, or simply “OptaML” or “OptaML Pro.”

### BRIEF DESCRIPTION OF THE DRAWINGS

FIG. 1 shows an embodiment of a test and measurement instrument.

FIG. 2 shows an example of a user menu in a test and measurement instrument.

FIG. 3 shows examples of two different tensor image configurations.

FIG. 4 shows a block diagram of an embodiment of splitting a long waveform into sequential segments to build a three-dimensional tensor image.

FIG. 5 shows a block diagram of an embodiment of separating S-parameter waveforms into real and imaginary waveforms to build a three-dimensional tensor image.

FIG. 6 shows a block diagram of an embodiment of detecting a repeating pattern to build a three-dimensional tensor image.

FIG. 7 shows an example of a long waveform.

FIG. 8 shows an example of mapping waveform segments into a tensor image.

FIG. 9 shows a three-dimensional view of the image of FIG. 8.

FIG. 10 shows an example of three, three-dimensional tensor images in each color channel of an RGB image.

FIG. 11 shows a graph of three port S-parameters in dB versus frequency for a diplexer.

FIG. 12 shows a mapping of real and imaginary parts of S-parameter waveform data into an image with spacing between the parts.

FIG. 13 shows a three-dimensional view of the image of FIG. 12.

FIG. 14 shows an example of three, three-dimensional tensor images in each color channel of an RGB image for S-parameters with no spacing between the parts.

FIG. 15 shows an alternative construction of one of the images of FIG. 14 without spacing.

FIG. 16 shows a graph of three short waveform, or pulse, images.

FIG. 17 shows a mapping of repetitions of a short waveform, and repetitions of other short waveforms.

FIG. 18 shows a three-dimensional view of the image of FIG. 17.

FIG. 19 shows a block diagram of a user interface for a tensor builder.

### DETAILED DESCRIPTION

Embodiments of the disclosure generally include a method to create higher efficiency 3D RGB image tensors that incorporates three channels of reference tuning parameters or S-parameters or other types of data. Previous implementations of RGB image tensors, for example in those described in the '954 application and the '829 application, use two dimensions of the image for X versus Y waveform data, and the third dimension was a histogram of overlaid repeats of short waveform patterns. In contrast, embodiments of this disclosure allow for many S-parameter vectors to be placed into a single image whereas that was not feasible with the previous implementations. In addition, embodiments of the disclosure enable placing waveforms in the image that are longer than the width of the image. The significance of this is that it allows pretrained networks such as Resnet18 with an image size space of 244 pixels×244 pixels×256 pixel brightness/intensity levels, times three color channels, to be used with transfer learning. This is a key factor that provides a major competitive advantage of processing waveforms into the highest performing neural networks in the industry. This allows for more accurate results and far less engineering time to achieve those results.

Generally, tensor images created according to embodiments of the disclosure have many novel aspects. These include three color channels for waveforms from three different reference tuning of device under test (DUT), representation of parameters such as temperature and noise as bar graphs in the images, orientation of waveform in the XYZ image space, where X represents time or frequency, and where Z represents magnitude of the data, and Y represents another waveform or S-parameter vector, which may be seen as a number of rows.

Other novel aspects include representation of many S-parameters in one image, representation of waveforms longer than the image width. Additionally, the rows of the data vectors may have a minimum spacing of no less than neural net correlation filter dimension, or row spacing of 1 for cases of repeated waveform segments so that neural net correlation filters overlap them. The spacing of 1 may apply to any case. Additionally, each individual color channel in the image may contain many short pattern waveforms that are not overlaid on each other in the XY image plane.

However, to keep the convolution layer filters in the deep learning network from correlating different waveforms that should remain isolated in the image, the waveforms up the Y axis may be spaced a distance equal to or greater than the span of the convolution filters. Using this concept allows a short pattern waveform placed into the image to be wrapped with segments spaced by the length of convolution filters in the network layers to avoid aliasing effects.

As mentioned above, the embodiments allow longer length short pattern waveforms to be fit into the 244 X axis length in the fixed image size into a Resnet18 pretrained network using transfer learning. One of the competitive advantages of all the elements of this image tensor design enables the use of pretrained deep learning networks to identify and process waveform inputs. These networks are the highest performing, most accurate networks in the industry. This means it can take far less engineering time to implement and train one of these networks and obtain the desired accuracy for waveform processing.

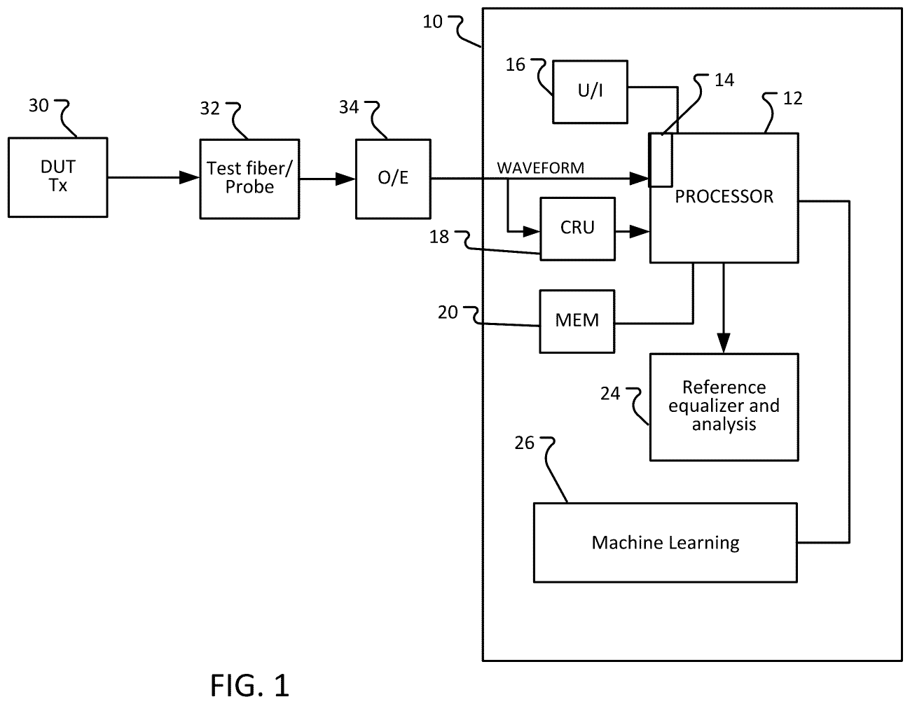

The machine learning system may take the form of programmed models operating on one or more of the processors. The embodiments may involve a test and measurement instrument having one or more processors executing code that causes the processors to perform the various tasks. FIG. 1 shows an embodiment of a testing setup in the instance of an optical transmitter 30 as a device under test (DUT). The testing setup includes a test and measurement system that may include a test and measurement instrument such as an oscilloscope 10. The test and measurement instrument 10 receives a signal from the DUT 30 through an instrument probe 32. In the case of an optical transmitter, the probe will typically comprise a test fiber coupled to an optical to electrical converter 34 that provides a signal to the test and measurement instrument through one or more ports 14. Two ports may be used for differential signaling, while one port is used for single-ended channel signaling. The signals are sampled and digitized by the instrument to become waveforms. A clock recovery unit (CRU) 18 may recover the clock signal from the data signal if the test and measurement instrument 10 comprises a sampling oscilloscope for example. A software clock recovery can be used on a real-time oscilloscope.

The test and measurement instrument has one or more processors represented by processor 12, a memory 20, and a user interface 16. The memory may store executable instructions in the form of code that, when executed by the processor, causes the processor to perform tasks. User interface 16 of the test and measurement instrument allows a user to interact with the instrument 10, such as to input settings, configure tests, etc. The test and measurement instrument may also include a reference equalizer and analysis module 24.

The embodiments here employ machine learning in the form of a machine learning network 26, such a deep learning network. The machine learning network may include a processor that has been programmed with the machine learning network as either part of the test and measurement instrument, or to which the test and measurement instrument has access through a connection. As test equipment capabilities and processors evolve, one or more processors such as 12 may include both.

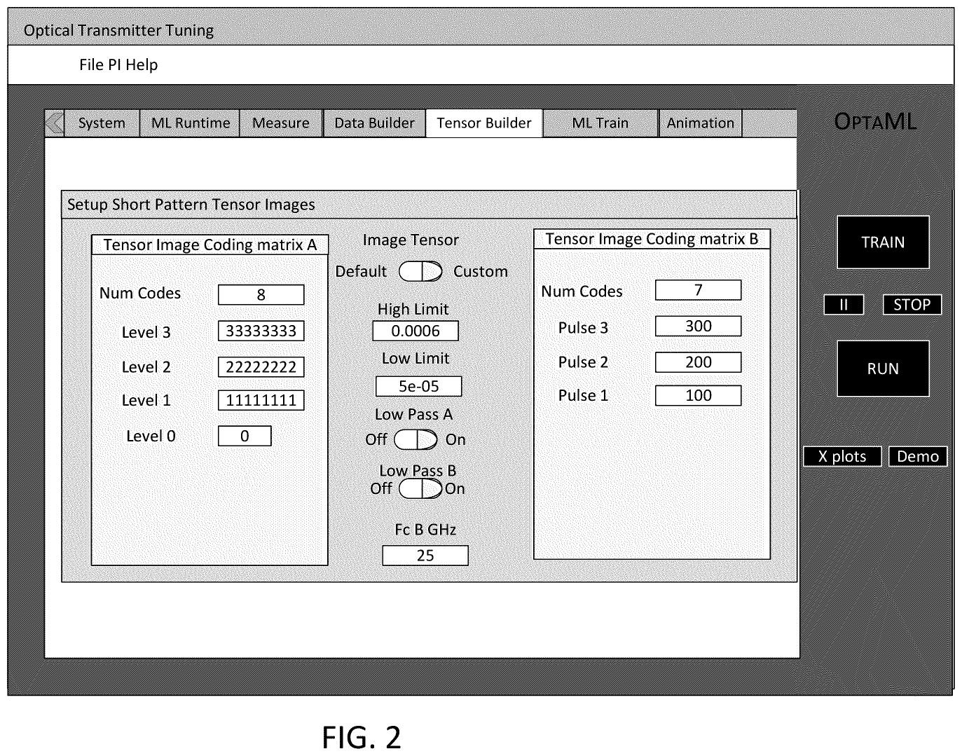

In an embodiment, the user interface may present an OptaML™ Pro training menu, such as the one shown in FIG. 2. The menu presents control parameter options in the Tensor Builder menu tab of the OptaML™ Pro training menu. The settings of these parameters used for training the deep learning network shall also be used for run-time predictions made by the network after it has been trained. The embodiments herein will have new menu control elements added to setup how the waveform or S-parameter data will be fit into the image. Also, some embodiments may do the image setup behind the scenes and not use a menu.

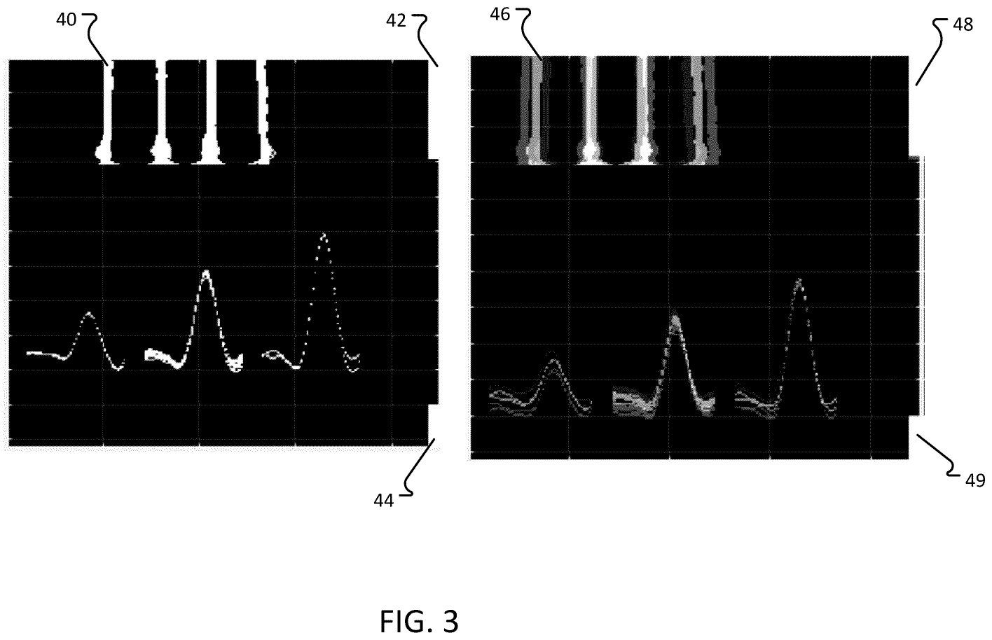

FIG. 3 shows an example of the current image tensors that are used by, for example, the test system described in the '954 application and the '829 application. The image on the left is a monochrome image with the same short pattern waveform segments in all three-color channels of the image. The long record input waveform is a PAM4 PRBS waveform. The vertical straight lines in the two tensor images such as 40 each represent a segment of the waveform where the code/symbol stays constant over several UI intervals. Those “levels” images were rotated 90 degrees before placing them in the image to avoid having them overlap with the pulse images. These levels images allow the deep learning to see the effects of DUT tuning parameters that effect gain and offset and linearity of the distance between the levels. The objective of the deep learning network is to be able to look at these images and predict what the optimal tuning parameters of the DUT should be. The DUT has parameters that are FFE taps for a feed forward equalizer. The short pattern pulse sequences in the image were laid out end to end and they are the view that most easily allows the network to see the effect of FFE taps settings.

The image on the left is for feeding to the deep learning network so that it can predict a single measurement of TDECQ. Only one waveform input is needed to do that. The left image also has two bar graphs 42 and 44. One to represent the temperature at which the waveform was measured, and the other represents the noise that was filtered off the short waveforms to make their relevant features more visible to the deep learning network.

The three-color image tensor on the right is used for predicting the optimal tuning parameters of the DUT. The algorithm uses three reference sets of parameters into the DUT to get three waveforms, then places each of the short patterns output of each waveform into one of the three color channels in the image, with the straight lines at the top of the image in all three colors such as 46. This includes separate bar graphs 48 and 49 for noise and temperature in each color channel of the image.

However, this current tensor image organization limits each waveform to the XY axis of the XYZ image space. The Z axis is used for making a histogram of multiple instances of each waveform in the long record. In contrast, embodiments of the disclosure modify the way the short pattern waveforms segments or S-parameter segments are organized in the image to more efficiently use the available data space in the image, and to do this in a manner that situates the waveform orientations to best allow the features of the waveform to be recognized, i.e., extracted, using the convolution layers of the deep learning networks.

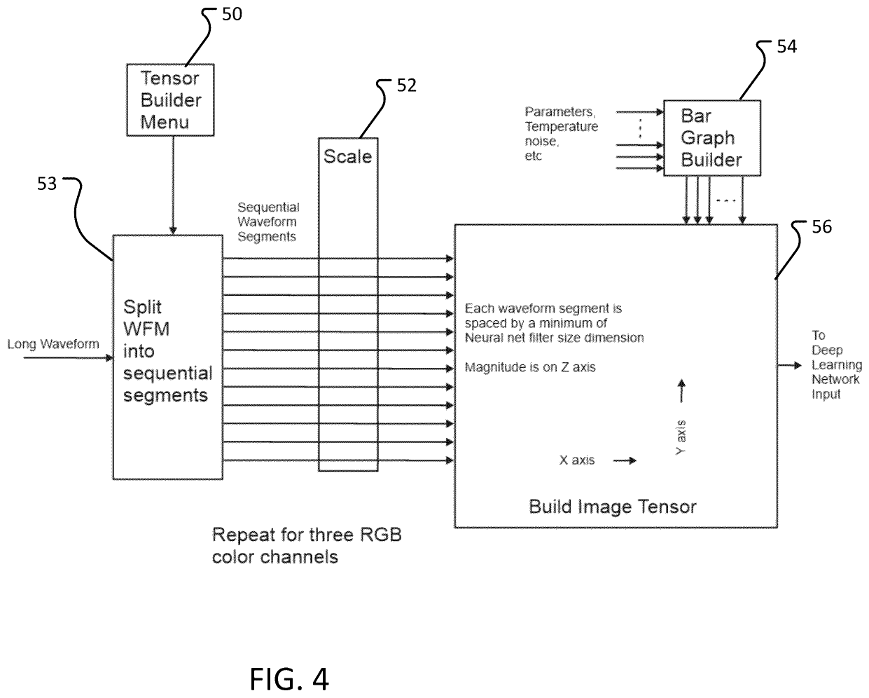

FIGS. 4-6 show different ways the three-dimensional (3D) tensors are built. In these figures, the user employs the Tensor Builder Menu 50 to set up how system should build the tensor image. In FIG. 4 the selection results in the tensor image being built by first splitting a long waveform into sequential segments at 53. The Scale block 52 scales the waveform data to fit within the magnitude range of 0 to 255 for the Z-axis of an RGB image. The Bar Graph Builder block 54 receives external parameters such as temperature, noise, or other and creates an area image with a magnitude value that is proportional to the parameter. These bar graph area images are given to the Build Image Tensor block to place the image into the appropriate color channel.

The Build Image Tensor block 56 receives the data vector and the bar graphs and the specification of what spacing to use between what waveforms and then builds RGB image tensor to be used as input to the deep learning network for both training and prediction after it is trained. The system may implement these blocks in hardware or software in the one or more processors discussed above.

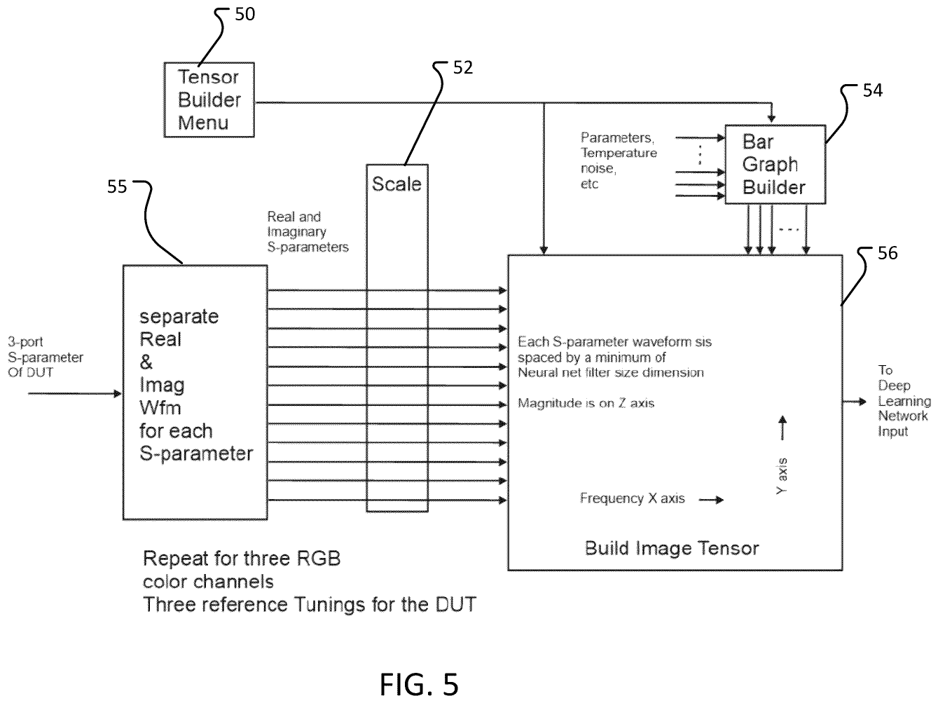

FIG. 5 shows the option to separate real and imaginary waveforms for each S-parameter at 55. This block received an S-parameter set and parameters from the tensor builder menu 50 to tell it which parameters to use out of the data set. Each S-parameter is represented by one real waveform as a function of frequency and one imaginary waveform as a function of frequency. For example, a 3-port passive diplexer has nine S-parameters. Only six of them are unique. Each has a real waveform and an imaginary waveform. There are 12 total waveforms that will be input to the image tensor builder. As mentioned above, the machine learning neural network may have correlation filters that have particular size. The placement of the waveforms may have a spacing determined by the size of these filters.

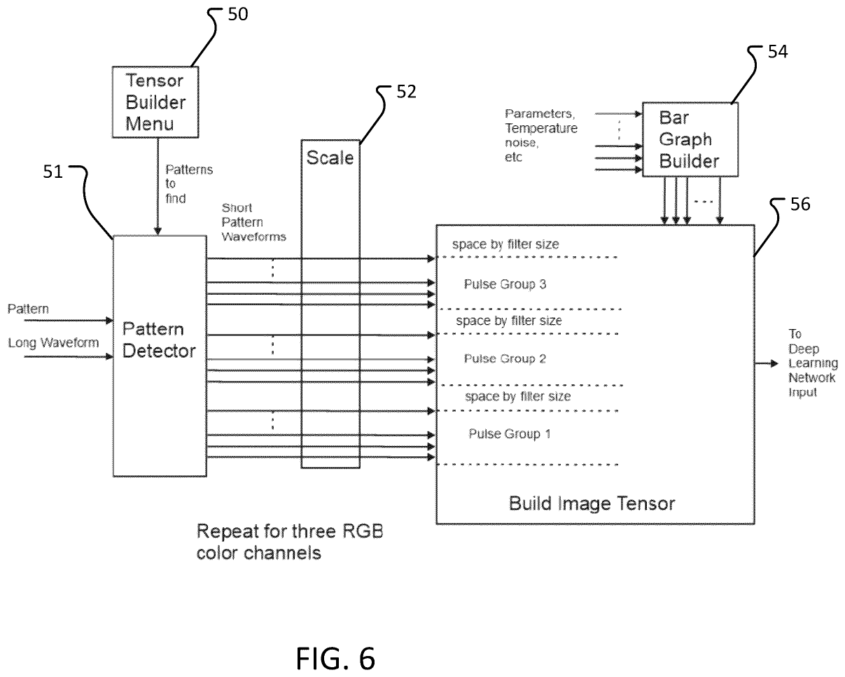

FIG. 6 shows the option to use a pattern detector to detect short patterns, or pulses, in the waveform. The pattern detector block 51 receives a long waveform and a decoded pattern that is aligned with the waveform. The tensor builder menu 50 specifies what type of short patterns this block shall find in the waveform. It may be searching for 7 different patterns in one example. All instances of all seven patterns would be output for use in the image tensor. However, if the image tensor has a limit of 20 instances of each pattern, it will only use that many and ignore the rest.

Regarding the spacing, the tensor image builder will not place any extra rows of space between similar patterns in a group. The image will have spacing between groups of patterns with another group having a different pattern. The minimum spacing between unsimilar waveform groups corresponds to the size of the correlation filter in the neural network.

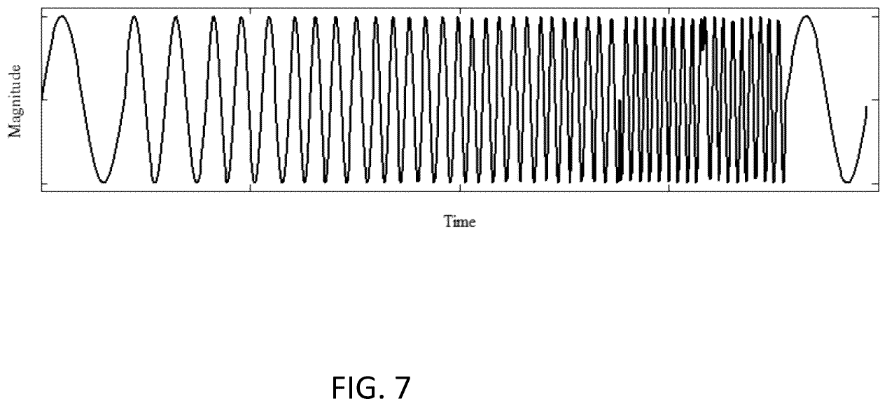

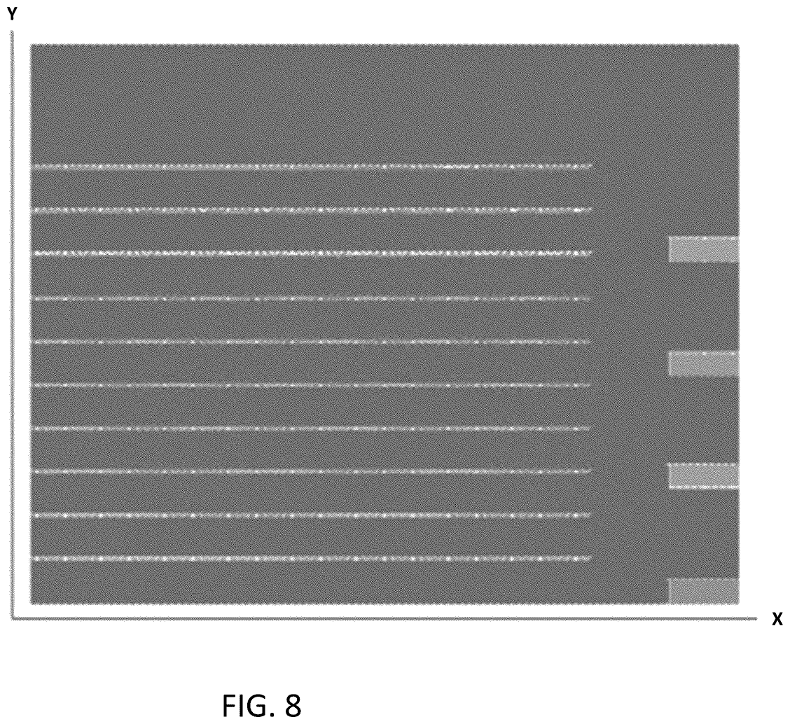

The discussion now takes each of these three methods of building a tensor image in turn. FIGS. 7-11 address the approach of splitting a long waveform into multiple sequential segments. For this example, consider a waveform from a DUT that has 10 times more samples in it than the available width of the image tensor, which may equal 244 pixels in some embodiments. FIG. 7 shows one such example. Embodiments using this approach can handle that situation by splitting the waveform up into 10 segments. The tensor builder then places one of the segments in one row of the XY image dimension with time on the X-axis, and magnitude on the Z-axis. The Y axis will contain different segments. FIG. 8 shows an XY rendition of these segments. The space between the lines results from the minimum row spacing. The figures show the bar graphs to the right side.

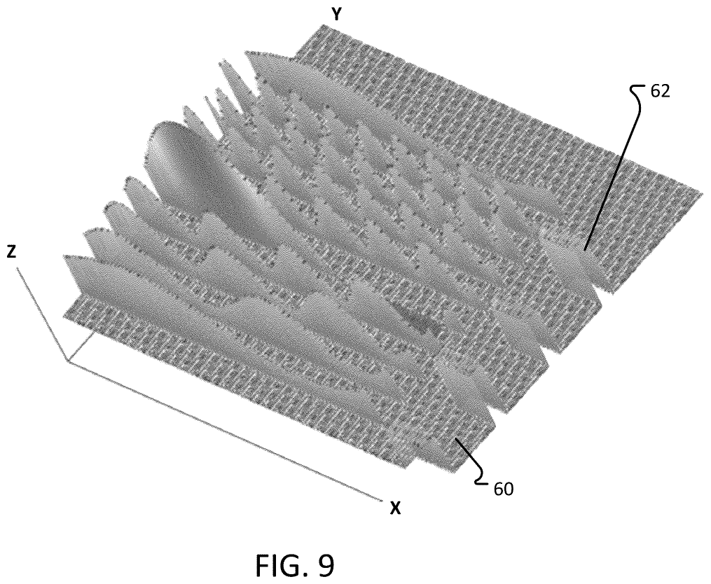

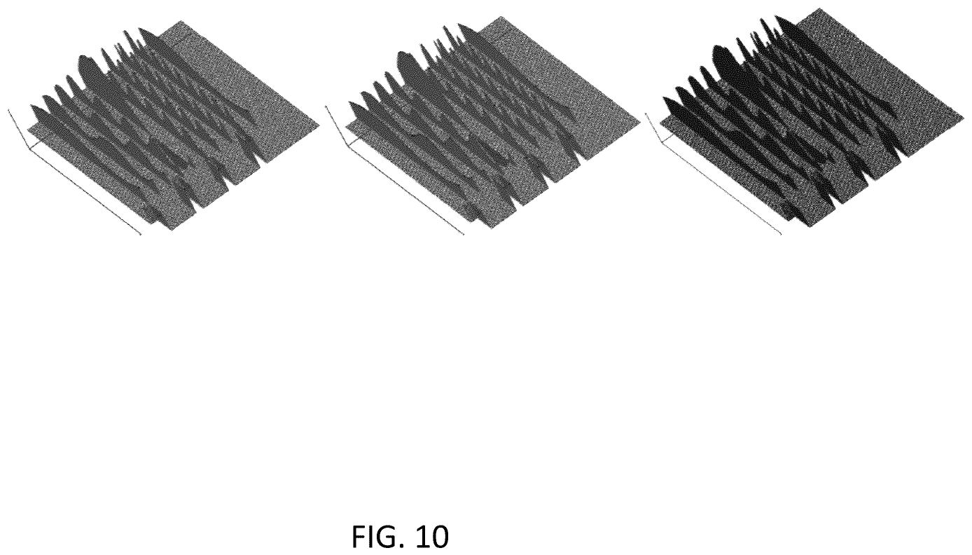

However, when one “tilts” the image so one can see it in three dimensions, the image now looks as shown in FIG. 9. The waveforms “run” across the X axis, and the rows run along the Y-axis, so one can see the spacing indicated by 60. The bar graphs such as 62 now appear in 3D, and the magnitudes of each segment extend up along the Z axis. The 3D image contains more information than the previous tensor images discussed above. In some embodiments, the DUT undergoes tuning to the operational parameters three times, once for each of a set of reference parameters. FIG. 10 shows the resulting 3D tensor images for each of these sets, each contained in a separate channel of a red-green-blue (RGB) image, from left to right in the image.

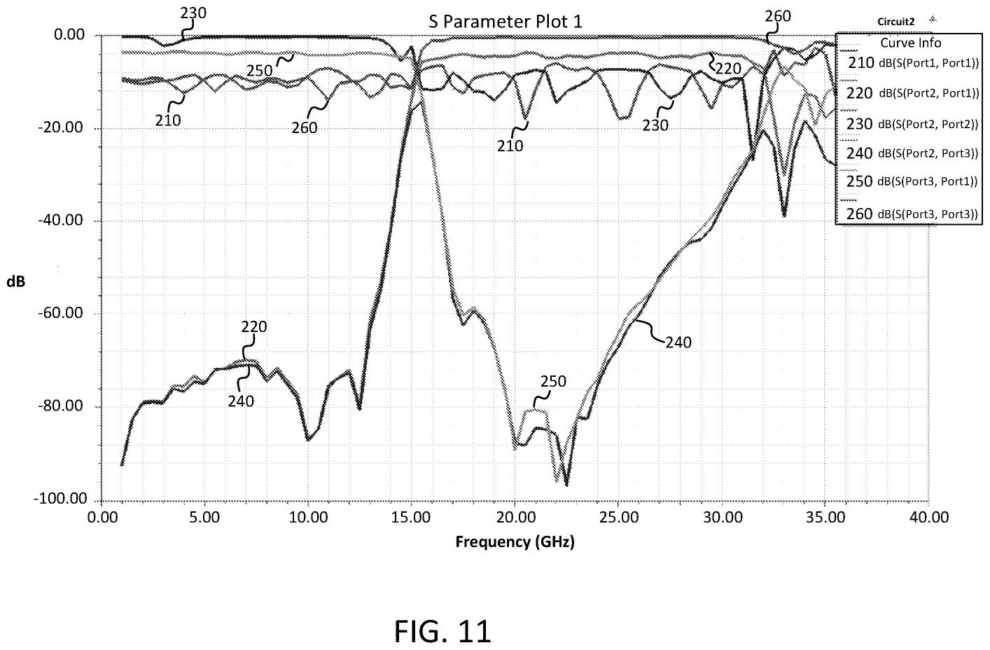

FIGS. 11-15 show an example of how one tensor image can represent a full three port set of S-parameters according to some embodiments. Consider a 3-port passive diplexer which has nine S-parameters, where six of them are unique. Each S-parameter comprises a set of complex values as a function of frequency. Therefore, each S-parameter has a real and an imaginary frequency domain waveform placed into one row of the tensor image with the magnitude on the Z-axis of the image.

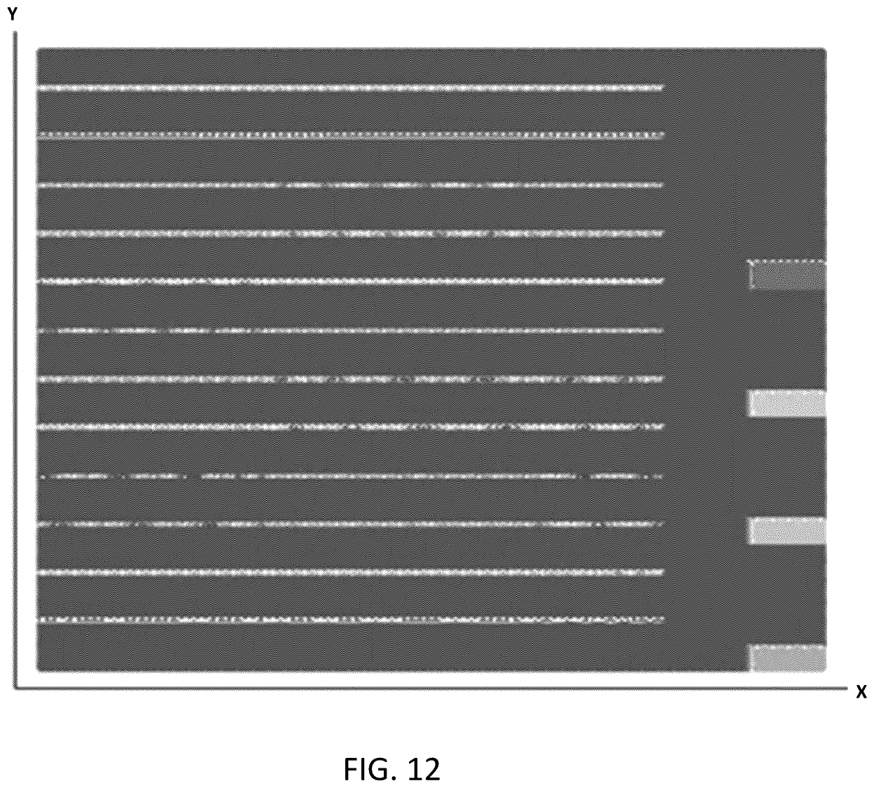

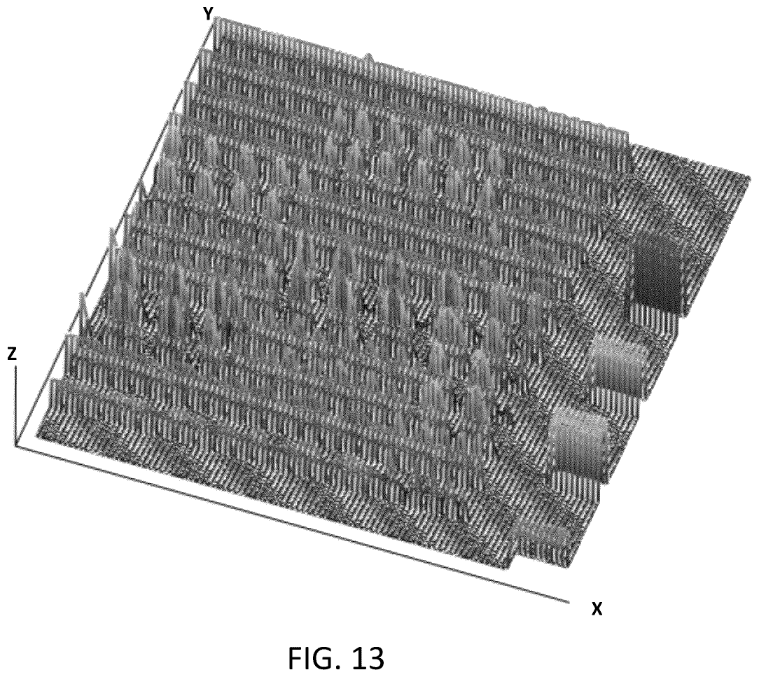

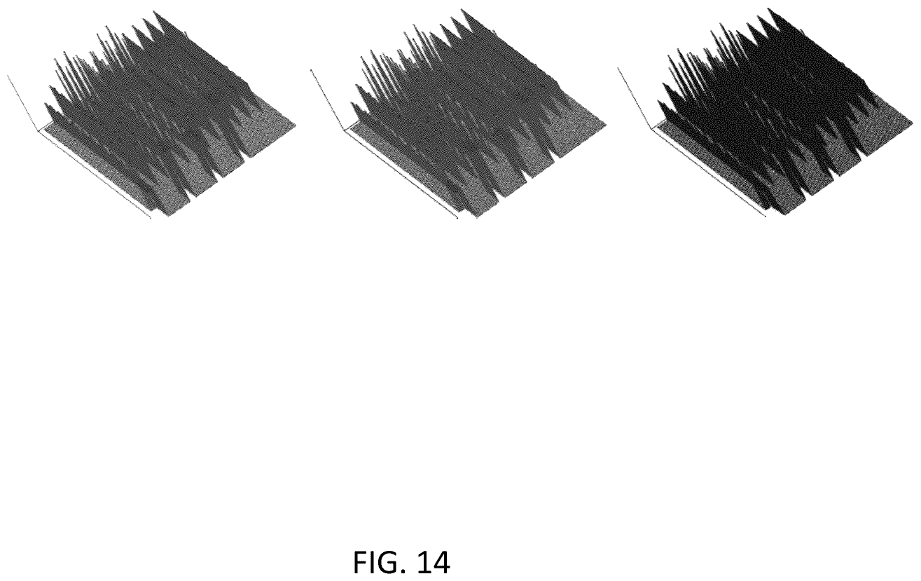

FIG. 11 shows a plot of the magnitude in dB on the vertical axis with frequency on the horizontal axis, with all six of the unique S-parameters for the diplexer are shown in the plot. FIG. 12 shows the 12 waveforms of this example in an XY display. The bar graphs are shown to the right side. FIG. 13 shows the tilted view. The color of the image in FIG. 13 depends upon which of the reference tuning parameter sets from the DUT produced the results. FIG. 14 shows the three separate images.

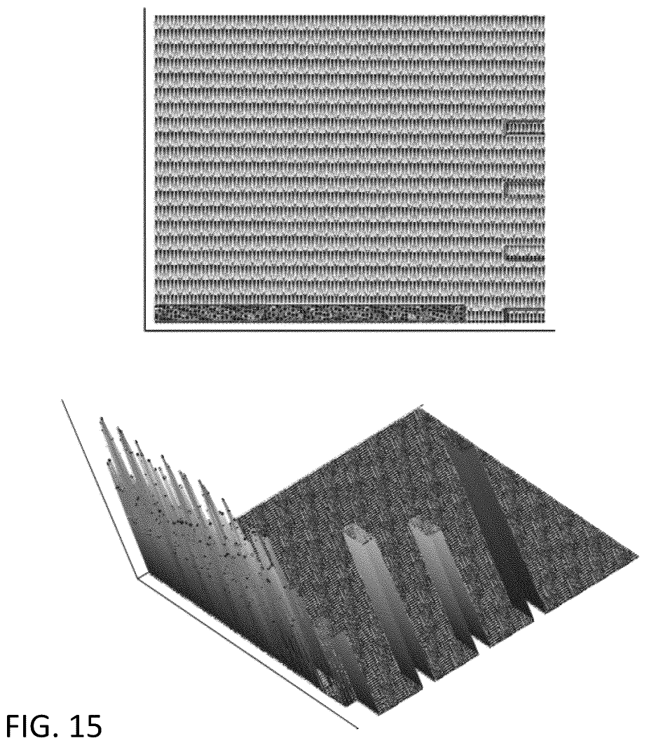

As shown in the tilted view of FIG. 13, one can see the spacing between the waveform rows. An alternative would have no spacing between rows, as some embodiments of the disclosure also allow the possibility of having no spacing between the S-parameter rows. The correlation filters will overlap multiple rows, but they do the correlation in a deterministic way that may still be suitable for the purpose of making desired predictions. However, if this results in not enough resolution to determine desired features, then spacing may be added. Using no spacing allows for the possibility of packing even more input data into the tensor image channels. FIG. 15 shows the XY layout and the tilted version with no spacing. As one can sec, this image has much more room for more data.

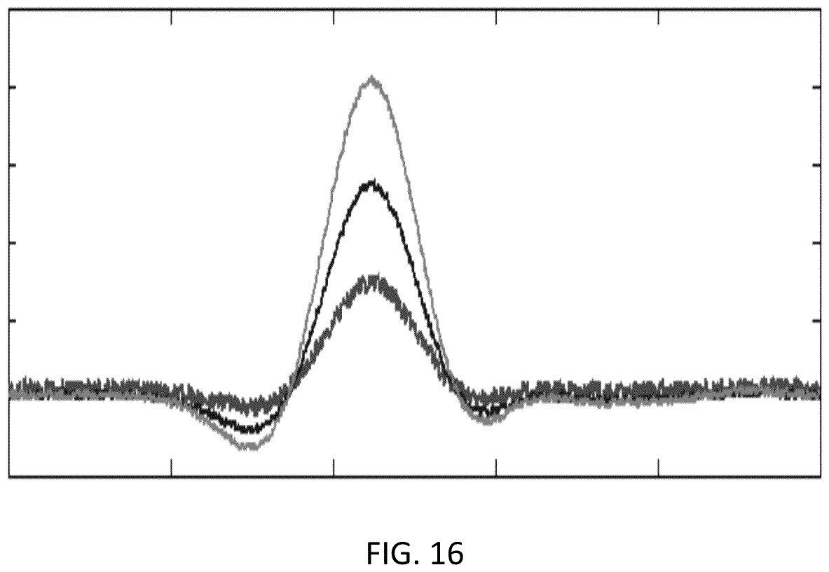

FIGS. 16-18 show the graphs for the embodiments that use short pattern waveforms, or pulses. FIG. 16 shows three PAM4 (pulse amplitude modulation-4) pulse sequences. This allows the collection of multiple repeats of a short pattern waveform out of long record waveform and includes them all into the image. Currently the approach puts waveforms on the XY axis and the Z axis histograms the repeated waveform cycles. According to some embodiments of this disclosure, the repeated waveform segments may be placed in adjacent rows, with no spacing between the rows. This way the correlation filters in the input layers of the neural network will span over repeated waveforms by the width of the filter. Resnet18 has a filter of 7×7.

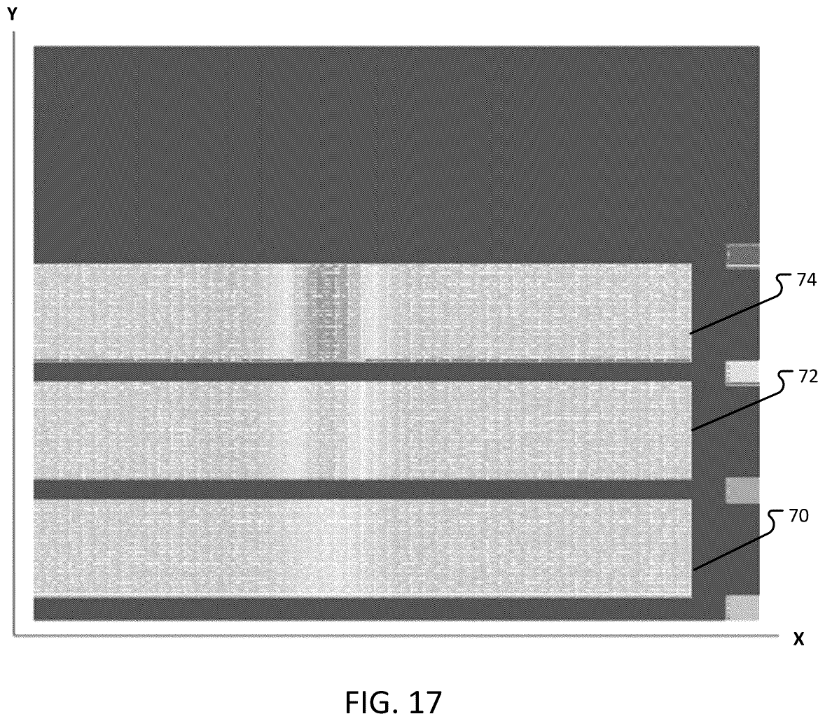

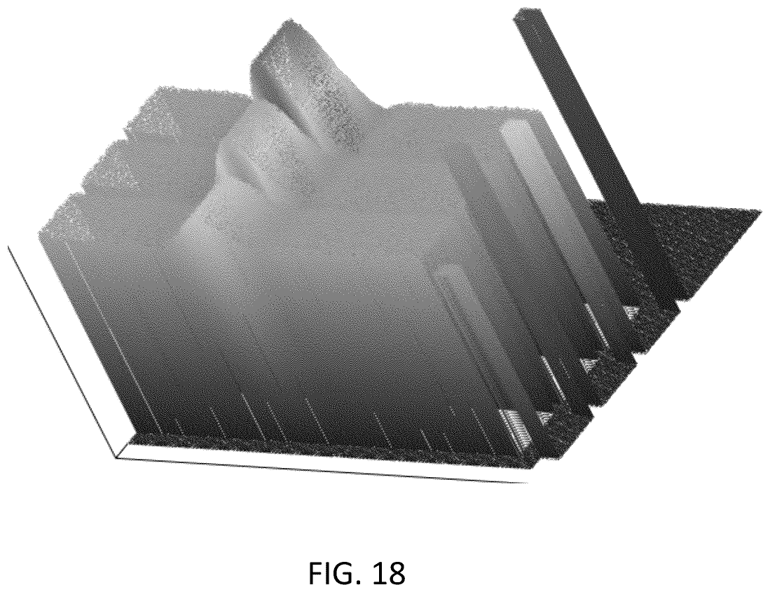

Consider three different pulse sequence from PAM4 level 0 to 1 and 0 to 2 and 0 to 3 as is currently used in OptaML™ Pro. Each pulse instance may repeat 10 times in the long record and placed into the image as a group with no spacing. The second group of 10 pulses with different amplitude may be placed into the image with spacing from the last group of seven rows for a Resnet18 network, and then the pulses in the group would have no spacing. Finally, the third pulse would be placed in the image with spacing of seven from the last group and no spacing for pulses in the group. FIG. 17 shows the three different groups of rows 70, 72, and 74, representing repetition of a same pulse within each group of rows. As in the other examples, the bar graphs reside at the right side of the image. FIG. 18 shows the tilted image. The single image would reside in one of the three color channels of the RGB image.

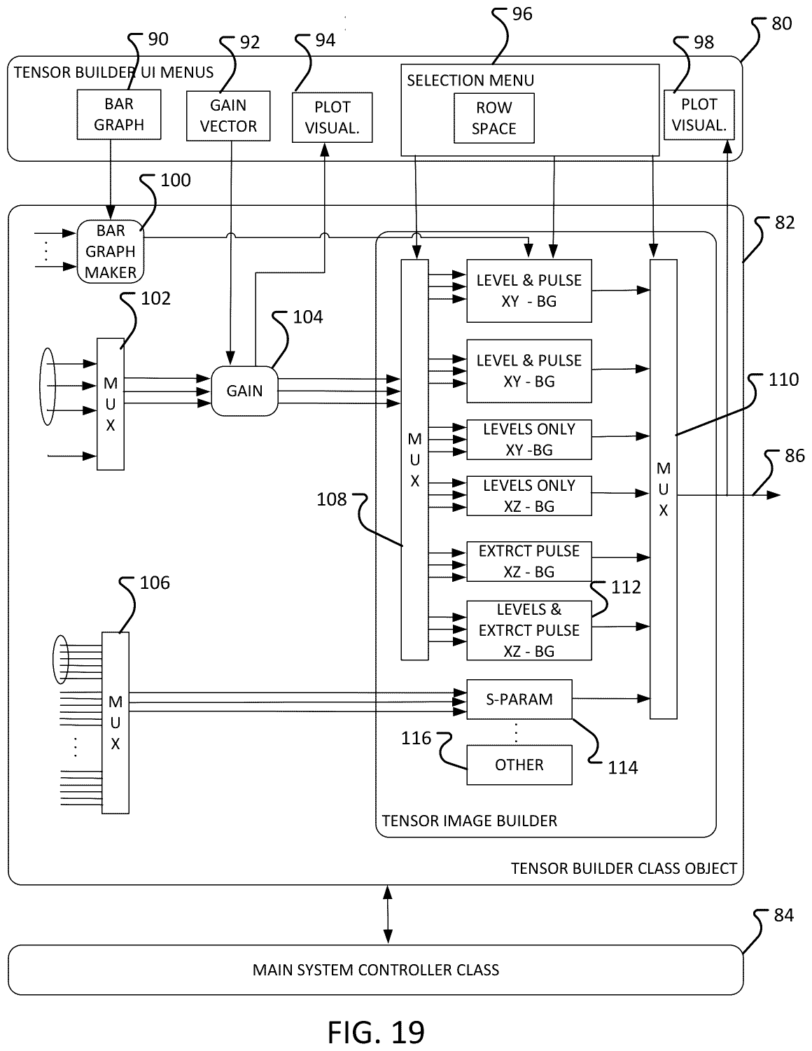

The Tensor Builder class object and user interface interactions allow implementation of these different approaches to building the 3D tensor image. FIG. 19 shows a block diagram of these elements.

The Tensor Builder user interface (UI) 80 controls which tensor builder algorithms or formatting to use and provides UI controls for configuration of it. This block includes many different types of controls. The Bar Graph Controls 90 provide controls such as whether to include a bar graph, and what kind of bar graph image to place into the main tensor image. Gain Vector UI Controls 92 provides controls for selecting a type of algorithm for gain control, and then the primary control elements that it may require. The Plot Visualizer for Gain vectors 94 allows the customer to visualize the settings for the gain control vector to aid them in setting it up and making sure the result is correct and usable. This comprises part of debugging the system setup for training and for runtime prediction. The Selection Menu 96 for type of tensor image allows the user to select which tensor image type to build. As shown above, the system has many different ways in which to build a tensor image. This menu also provides the needed UI for each of the types. The Tensor Image Plot Visualizer 98 aids in setting up menus controls for building the tensor during training. It is also needed for purposes of system maintenance and debugging.

The Tensor Builder UI Menus block 80 also includes a Row Spacing Control UI. This determines how to pack the data into the rows of the image. As discussed above, with no spacing the 7×7 correlation filters in the deep learning network will overlap the rows in a deterministic way. However, some applications may require spacing so that the correlation does not overlap other rows of data. This control adds flexibility to how the tensor image is constructed. The block 80 also includes the Gain Vector Control Menu 92 for increasing resolution of low-level parts of the pulse response in order to increase the number of FFE taps the deep learning network is able to predict for the user, when that output is selected.

The Tensor Builder Class 82 contains basic block elements for the purpose of creating tensor images for input to deep learning networks. Input typically comprises waveform data or S-parameter data. However, the system can be expanded to other types of input data. This block also includes the Bar Graph Image Maker 100 that receives various parameters such as temperature, noise, and others. It then creates small bar graphs images that may then be combined into the final tensor image. Block 82 also includes various multiplexers just to illustrate that the UI may select which algorithms, or in the case of S-parameters and waveforms, multiple loops may be performed by algorithms to bring the data into the tensor image.

The Tensor Image Builder uses the specified image building block to make image tensors. Multiplexer (MUX) 102 receives inputs for the image building blocks. The top group represents the inputs for three reference groups configured as RGB data, and the lower arrow is the monochrome input. Multiplexer 106 has three sets of inputs, each input set, such as the upper set of six inputs, representing the real and imaginary portions of an S-parameter for each of the three reference sets of parameters. While only three S-parameters are shown, many more could be included. The Gain Vector 104 block applies the gain set by the Gain Vector UI 92 to increase resolution as a function of time. The output selected by the MUX 102 goes to a second MUX 108 that sends the data to each of the image building blocks. The image building blocks are either XY or XZ, and include bar graph data (BG). The MUX 110 then governs which block is output when to the pre-trained neural network as output 86.

The Main System Controller Class 84 has the responsibility for looping through all the input data and metadata during training to build arrays of image tensors to associate with metadata. It also controls the same image building procedure for use during run time prediction using the deep learning network after it has been trained.

This disclosure has described three examples of methods of building 3D RGB image tensors to represent waveforms and S-parameters as input to pretrained deep learning networks, using transfer learning. It embodies the three reference tunings data from a DUT where the output waveforms of each tuning are placed into a separate RGB color channel. It also covers the concept of creating image bar graphs to represent input parameters such as temperature and noise, or other. It includes the concept of position waveforms in the image such their magnitude is on the Z-axis of the image, and time or frequency is on the X-axis. The Y-axis then represents multiple waveforms or S-parameter data sets.

Another aspect of this disclosure is that the minimum spacing between unsimilar waveforms or groups of similar waveforms is the dimension of the deep learning network correlation filters. Resnet18 provides an example of a pretrained network and has a filter size of 7×7. This results in a minimum spacing of 7 between unlike waveforms. Embodiments of the disclosure allow the highest performing and most accurate pretrained networks in the industry to be retrained using transfer learning to associate waveforms and S-parameters for use in test and measurement, and optimal tuning of DUTs. Using this image-based approach also has multiple advantages over just using raw waveform data as inputs to the deep learning networks. For example, the image-based method prunes the long data waveform of unnecessary elements making the predictions from the neural net more accurate. It also allows the input to the network to be independent of record length, and baud rate, and pattern type, etc. Overall, these inputs allow the machine learning network to output the desired prediction, which may comprise optimal tuning parameters, TDECQ, FFE taps, etc.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a test and measurement instrument, comprising: a port to allow the instrument to connect to a device under test (DUT) to receive waveform data; a connection to a machine learning network; and one or more processors configured to execute code that causes the one or more processors to: receive one or more inputs about a three-dimensional (3D) tensor image; scale the waveform data to fit within a magnitude range of the 3D tensor image; build the 3D tensor image in accordance with the one or more inputs; send the 3D tensor image to the machine learning network; and receive a predictive result from the machine learning network.

Example 2 is the test and measurement instrument of Example 1, wherein the code that causes the one or more processors to build the 3D tensor image causes the one or more processors to: build three 3D tensor images, one 3D tensor image for each of a set of reference parameters; and place each of the 3D tensor images on a different color channel of a red-green-blue color image.

Example 3 the test and measurement instrument of either of Examples 1 or 2, wherein the one or more processors are further configured to execute code that causes the one or more processors to place bar graphs of one or more operating parameters into the 3D tensor image.

Example 4 is the test and measurement instrument of any of Examples 1 through 3, wherein the code that causes the one or more processors to build the 3D tensor image comprises code that causes the one or more processors to: split the waveform data into multiple segments when the waveform data has more samples than an available width of the 3D tensor image; and place each one of the multiple segments in separate rows of a number of rows in the 3D tensor image, with time being along an x-axis, the number of rows being along y-axis, and magnitude of each segment being along a z-axis.

Example 5 is the test and measurement instrument of Example 4, wherein the code that causes the one or more processors to place each one of the multiple segments in separate rows further comprises code that causes the one or more processors to place each one of the multiple segments in a separate row spaced apart from rows containing others of the multiple segments by a predetermined number of rows based upon a size of internal neural network convolutional filters in the machine learning network.

Example 6 is the test and measurement instrument of any Examples 1 through 5, wherein the code that causes the one or more processors to build the 3D tensor image comprises code that causes the one or more processors to: receive the waveform data, wherein the waveform data is S-parameter waveform data; split the waveform data for each S-parameter into real and imaginary waveforms; and place each of the real waveforms and each of the imaginary waveforms into separate rows of the 3D tensor image, with frequency being along an x-axis, the number of rows being along y-axis, and magnitude of each waveform being along a z-axis.

Example 7 is the test and measurement instrument of Example 6, wherein the code that causes the one or more processors to place each of the real waveforms and each of the imaginary waveforms into separate rows comprises code that causes the one or more processors to place each of the real waveforms and the imaginary waveforms into separate rows spaced apart from others of the real and imaginary waveforms by a predetermined number of rows based upon a size of internal neural network convolutional filters in the machine learning network.

Example 8 is the test and measurement instrument of Example 6, wherein the code that causes the one or more processors to place each of the real waveforms and each of the imaginary waveforms into separate rows comprises code that causes the one or more processors to place each of the real waveforms and the imaginary waveforms into separate rows with no spaces between rows.

Example 9 is the test and measurement instrument of any of Examples 1 through 8, wherein the code that causes the one or more processors to build the 3D tensor image comprises code that causes the one or more processors to: capture multiple repetitions of a short pattern waveform, the short pattern waveform being identified by the one or more inputs about the 3D tensor image; and place each repetition of the short pattern waveform in a row of the image to form a group of rows with no spacing between them, the 3D tensor image having time along an x-axis, the number of rows along a y-axis, and magnitude along a z-axis.

Example 10 is the test and measurement instrument of Example 9, wherein the one or more processors are further configured to execute code that causes the one or more processors to: capture multiple repetitions of at least one other short pattern waveform; and place each repetition of the at least one other short pattern waveform in at least one other group of rows with no spacing between the rows of the other group of rows, the spacing between groups of rows being based upon a size of internal neural network convolutional filters in the machine learning network.

Example 11 a method, comprising: receiving waveform data from one or more device under test (DUT); receiving one or more inputs about a three-dimensional (3D) tensor image; scaling the waveform data to fit within a magnitude range of the 3D tensor image; building the 3D tensor image in accordance with the one or more inputs; sending the 3D tensor image to a pre-trained machine learning network; and receiving a predictive result from the machine learning network.

Example 12 is the method of Example 11, further comprising: building three 3D tensor images, one 3D tensor image for each of a set of reference parameters; and placing each of the 3D tensor images on a different color channel of a red-green-blue color image.

Example 13 is the the method of either of Examples 11 or 12, further comprising placing one or more bar graphs of one or more operating parameters in the 3D tensor image.

Example 14 is the method of any of Examples 11 through 13, wherein building the 3D tensor image comprises: splitting the waveform data into multiple segments when the waveform data has more samples than an available width of the 3D tensor image; and placing each one of the multiple segments in one row of a number of rows in the 3D tensor image, with time being along an x-axis, the number of rows being along y-axis, and magnitude of each segment being along a z-axis.

Example 15 is the method of Example 14, wherein placing each one of the multiple segments in one row further comprises spacing rows for each one of the multiple segments apart from the other rows by a predetermined number of rows based upon a size of internal neural network convolutional filters in the machine learning network.

Example 16 is the test and measurement instrument of any of Examples 11 through Example 15, wherein building the 3D tensor image comprises: receiving the waveform data, wherein the waveform data is S-parameter waveform data; splitting the waveform data for each S-parameter waveform data into real and imaginary waveforms; and placing each of the real waveforms and each of the imaginary waveforms into separate rows of the 3D tensor image, with frequency being along an x-axis, the number of rows being along y-axis, and magnitude of each waveform being along a z-axis.

Example 17 is the method of Example 16, wherein placing each of the real waveforms and each of the imaginary waveforms into separate rows comprises placing each of the real waveform and the imaginary waveforms into separate rows spaced apart from others of the real and imaginary waveforms by a predetermined number of rows based upon a size of internal neural network convolutional filters in the machine learning network.

Example 18 is the method of Example 16, wherein placing each of the real waveforms and each of the imaginary waveforms into separate rows comprises placing each of the real waveform and the imaginary waveforms into separate rows with no spaces between rows.

Example 19 is the method of any of Examples 11 through 18, wherein building the 3D tensor image comprises: capturing multiple repetitions of a short pattern waveform, the short pattern waveform being identified by the one or more inputs about the 3D tensor image; and placing each repetition of the short pattern waveform into a row of the image to form a group of rows for each short pattern waveform with no spacing between the rows, the 3D tensor image having time along an x-axis, the number of rows along a y-axis, and magnitude along a z-axis.

Example 20 is the method of Example 19, further comprising: capturing multiple repetitions of at least one other short pattern waveform; and placing each repetition of the at least one other short pattern waveform in at least one other group of rows with no spacing between them, the spacing between groups of rows being based upon a size of internal neural network convolutional filters in the machine learning network.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

I/We claim:

1. A test and measurement instrument, comprising:
a port to allow the instrument to connect to a device under test (DUT) to receive waveform data;
a connection to a machine learning network; and
one or more processors configured to execute code that causes the one or more processors to:
receive one or more inputs about a three-dimensional (3D) tensor image;
scale the waveform data to fit within a magnitude range of the 3D tensor image;
build the 3D tensor image in accordance with the one or more inputs;
send the 3D tensor image to the machine learning network; and
receive a predictive result from the machine learning network.

2. The test and measurement instrument as claimed in claim 1, wherein the code that causes the one or more processors to build the 3D tensor image causes the one or more processors to:
build three 3D tensor images, one 3D tensor image for each of a set of reference parameters; and
place each of the 3D tensor images on a different color channel of a red-green-blue color image.

3. The test and measurement instrument as claimed in claim 1, wherein the one or more processors are further configured to execute code that causes the one or more processors to place bar graphs of one or more operating parameters into the 3D tensor image.

4. The test and measurement instrument as claimed in claim 1, wherein the code that causes the one or more processors to build the 3D tensor image comprises code that causes the one or more processors to:
split the waveform data into multiple segments when the waveform data has more samples than an available width of the 3D tensor image; and
place each one of the multiple segments in separate rows of a number of rows in the 3D tensor image, with time being along an x-axis, the number of rows being along y-axis, and magnitude of each segment being along a z-axis.

5. The test and measurement instrument as claimed in claim 4, wherein the code that causes the one or more processors to place each one of the multiple segments in separate rows further comprises code that causes the one or more processors to place each one of the multiple segments in a separate row spaced apart from rows containing others of the multiple segments by a predetermined number of rows based upon a size of internal neural network convolutional filters in the machine learning network.

6. The test and measurement instrument as claimed in claim 1, wherein the code that causes the one or more processors to build the 3D tensor image comprises code that causes the one or more processors to:
receive the waveform data, wherein the waveform data is S-parameter waveform data;
split the waveform data for each S-parameter into real and imaginary waveforms; and
place each of the real waveforms and each of the imaginary waveforms into separate rows of the 3D tensor image, with frequency being along an x-axis, the number of rows being along y-axis, and magnitude of each waveform being along a z-axis.

7. The test and measurement instrument as claimed in claim 6, wherein the code that causes the one or more processors to place each of the real waveforms and each of the imaginary waveforms into separate rows comprises code that causes the one or more processors to place each of the real waveforms and the imaginary waveforms into separate rows spaced apart from others of the real and imaginary waveforms by a predetermined number of rows based upon a size of internal neural network convolutional filters in the machine learning network.

8. The test and measurement instrument as claimed in claim 6, wherein the code that causes the one or more processors to place each of the real waveforms and each of the imaginary waveforms into separate rows comprises code that causes the one or more processors to place each of the real waveforms and the imaginary waveforms into separate rows with no spaces between rows.

9. The test and measurement instrument as claimed in claim 1, wherein the code that causes the one or more processors to build the 3D tensor image comprises code that causes the one or more processors to:
capture multiple repetitions of a short pattern waveform, the short pattern waveform being identified by the one or more inputs about the 3D tensor image; and
place each repetition of the short pattern waveform in a row of the image to form a group of rows with no spacing between them, the 3D tensor image having time along an x-axis, the number of rows along a y-axis, and magnitude along a z-axis.

10. The test and measurement instrument as claimed in claim 9, wherein the one or more processors are further configured to execute code that causes the one or more processors to:
capture multiple repetitions of at least one other short pattern waveform; and
place each repetition of the at least one other short pattern waveform in at least one other group of rows with no spacing between the rows of the other group of rows, the spacing between groups of rows being based upon a size of internal neural network convolutional filters in the machine learning network.

11. A method, comprising:
receiving waveform data from one or more device under test (DUT);
receiving one or more inputs about a three-dimensional (3D) tensor image;
scaling the waveform data to fit within a magnitude range of the 3D tensor image;
building the 3D tensor image in accordance with the one or more inputs;
sending the 3D tensor image to a pre-trained machine learning network; and
receiving a predictive result from the machine learning network.

12. The method as claimed in claim 11, further comprising:
building three 3D tensor images, one 3D tensor image for each of a set of reference parameters; and
placing each of the 3D tensor images on a different color channel of a red-green-blue color image.

13. The method as claimed in claim 11, further comprising placing one or more bar graphs of one or more operating parameters in the 3D tensor image.

14. The method as claimed in claim 11, wherein building the 3D tensor image comprises:
splitting the waveform data into multiple segments when the waveform data has more samples than an available width of the 3D tensor image; and
placing each one of the multiple segments in one row of a number of rows in the 3D tensor image, with time being along an x-axis, the number of rows being along y-axis, and magnitude of each segment being along a z-axis.

15. The method as claimed in claim 14, wherein placing each one of the multiple segments in one row further comprises spacing rows for each one of the multiple segments apart from the other rows by a predetermined number of rows based upon a size of internal neural network convolutional filters in the machine learning network.

16. The test and measurement instrument as claimed in claim 11, wherein building the 3D tensor image comprises:
receiving the waveform data, wherein the waveform data is S-parameter waveform data;
splitting the waveform data for each S-parameter waveform data into real and imaginary waveforms; and
placing each of the real waveforms and each of the imaginary waveforms into separate rows of the 3D tensor image, with frequency being along an x-axis, the number of rows being along y-axis, and magnitude of each waveform being along a z-axis.

17. The method as claimed in claim 16, wherein placing each of the real waveforms and each of the imaginary waveforms into separate rows comprises placing each of the real waveform and the imaginary waveforms into separate rows spaced apart from others of the real and imaginary waveforms by a predetermined number of rows based upon a size of internal neural network convolutional filters in the machine learning network.

18. The method as claimed in claim 16, wherein placing each of the real waveforms and each of the imaginary waveforms into separate rows comprises placing each of the real waveform and the imaginary waveforms into separate rows with no spaces between rows.

19. The method as claimed in claim 11, wherein building the 3D tensor image comprises:
capturing multiple repetitions of a short pattern waveform, the short pattern waveform being identified by the one or more inputs about the 3D tensor image; and
placing each repetition of the short pattern waveform into a row of the image to form a group of rows for each short pattern waveform with no spacing between the rows, the 3D tensor image having time along an x-axis, the number of rows along a y-axis, and magnitude along a z-axis.

20. The method as claimed in claim 19, further comprising:
capturing multiple repetitions of at least one other short pattern waveform; and
placing each repetition of the at least one other short pattern waveform in at least one other group of rows with no spacing between them, the spacing between groups of rows being based upon a size of internal neural network convolutional filters in the machine learning network.
